(19) United States
(12) Patent Application Publication
(10) Pub. No.: US 2025/0035951 A1
(43) Pub. Date: Jan. 30, 2025

(54) FLOATING PROJECTION DEVICE

(71) Applicant: HTC Corporation, Taoyuan City (TW)

(72) Inventors: Jeo-Yi Lee, Taoyuan City (TW); Kuei-Chun Liu, Taoyuan City (TW); Wei Chun Chen, Taoyuan City (TW)

(73) Assignee: HTC Corporation, Taoyuan City (TW)

(21) Appl. No.: 18/357,165

(22) Filed: Jul. 24, 2023

(51) Int. Cl. G02B 30/56; G02B 1/10; G02B 5/10; G02B 5/30

(52) U.S. Cl. CPC G02B 30/56; G02B 1/10; G02B 5/10; G02B 5/3066; G02B 5/3083

(57) ABSTRACT

A floating projection device includes a mirror structure, an optical structure, an optical coating and a display. The optical structure covers the mirror structure, and forms an accommodating space with the mirror structure. The optical coating is disposed on the optical structure. The display is disposed in the accommodating space formed between the optical structure and the mirror structure, and is configured to transmit a plurality of image light beams to the optical structure.

### BACKGROUND

### Technical Field

The application relates to a floating projection device, and in particular, to a floating projection device that can improve the display effect.

### Description of Related Art

In the prior art, the floating projection device overlaps each other through two concave mirror structures, and forms an opening in the center of the mirror structure on the upper layer. A real object is set in the floating projection device. The image of the real object can generate multiple reflections in the floating projection device, penetrate the opening in the center of the mirror structure on the upper layer, and form a display image close to the real object above the floating projection device.

In the floating projection device of the above-mentioned prior art, the viewing angle of the display image generated by it is limited. Moreover, when the user observes the display image from above, it is easy to observe he real object inside the floating projection device through its opening at the same time, which will cause visual interference.

### SUMMARY

The present invention provides a floating projection device, which can improve the display effect.

The floating projection device of the present invention includes a mirror structure, an optical structure, an optical coating and a display. The optical structure covers the mirror structure, and forms an accommodating space with the mirror structure. The optical coating is disposed on the optical structure. The display is disposed in the accommodating space formed between the optical structure and the mirror structure, and is configured to transmit a plurality of image light beams to the optical structure.

Based on above, the floating projection device of the present invention sets the optical coating on the optical structure above. The optical coating can reflect or transmit the image light beams according to the polarization direction of the light beams, and the display image can be imaged above the floating projection device. In this way, the viewing angle of the display image generated by the floating projection device can be greatly improved, and the quality of the display image can be effectively improved.

### BRIEF DESCRIPTION OF THE DRAWINGS

FIG. 1 is a schematic diagram of the floating projection device according to an embodiment of the present invention.

FIG. 2 is a schematic diagram of an imaging method of the floating projection device according to an embodiment of the present invention.

FIG. 3 is a schematic diagram illustrating the details of the image light beams of the floating projection device according to the embodiment of the present invention.

FIG. 4 is a schematic diagram illustrating the imaging distance of the floating projection device according to an embodiment of the present invention.

FIG. 5A is a schematic diagram of the floating projection device according to an embodiment of the present invention.

FIG. 5B is a schematic diagram illustrating the traveling path of the image light beams of the floating projection device 500 in FIG. 5A.

FIG. 6A is a schematic diagram of the floating projection device according to an embodiment of the present invention.

FIG. 6B is a schematic diagram illustrating the traveling path of the image light beams of the floating projection device 600 in FIG. 6A.

### DESCRIPTION OF THE EMBODIMENTS

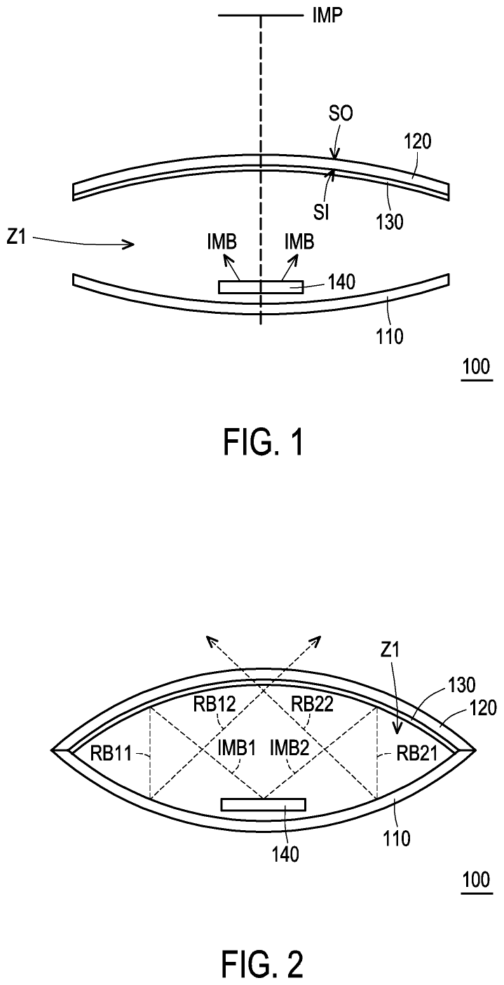

Referring to FIG. 1, FIG. 1 is a schematic diagram of the floating projection device according to an embodiment of the present invention. The floating projection device 100 includes a mirror structure 110, an optical structure 120, an optical coating 130 and a display 140. In the embodiment, the optical structure 120 is disposed above the mirror structure 110. Wherein, the optical structure 120 covers the mirror structure 110, and forms an accommodating space Z1 with the mirror structure 120. The optical coating 130 is disposed on the optical structure 120. Wherein, the optical coating 130 is disposed on an inner surface S1 of the optical structure 120 facing the mirror structure 110. The display 140 is disposed in the accommodating space Z1. The display 140 is configured to transmit a plurality of image light beams IMB to the optical structure 120.

In the embodiment, the optical coating 130 includes a phase retardation film layer and a polarization selective reflective film layer. Wherein, the polarization selective reflective film layer is set between the phase retardation film layer and the inner surface S1 of the mirror structure 110. The phase retardation film layer can change the polarization type of the received light beams, and the setting of the polarization selective reflective film layer can selectively reflect or transmit the received light beams according to the polarization type of the received light beams.

In the embodiment, the image light beams IMB transmitted by the display 140 can undergo multiple reflections and one transmission action on the mirror structure 110 and the optical coating 130, and form a real image of the display image outside the accommodating space Z1 formed between the optical structure 120 and the mirror structure 120, on an imaging plane IMP adjacent to an outer surface SO of the optical structure 120.

Through the above-mentioned imaging method, the display image, which can be seen from different angles and approximates the real object, can be produced, which can be called a hologram.

In the embodiment, the optical structure 120 may be a transparent structure. Besides, in the embodiment, both the mirror structure 110 and the optical structure 120 may be concave structures, and the concave surface of the mirror structure 110 and the concave surface of the optical structure 120 may face each other. The mirror structure 110 and the optical structure 120 have a first curvature radius and a second curvature radius respectively, wherein the first curvature radius and the second curvature radius are real numbers other than zero. In addition, the display 140 can be a liquid crystal display.

Regarding the travel path of the light beams in the embodiment of the present invention, referring to FIG. 2, which is a schematic diagram of an imaging method of the floating projection device according to an embodiment of the present invention. In FIG. 2, the display 140 can transmit the image light beams IMB1 and IMB2 toward the optical coating 130. The optical coating 130 can respectively reflect the image light beams IMB1 and IMB2 and generate reflected beams RB11 and RB21. The reflected beams RB11 and RB21 head towards the mirror structure 110. The mirror structure 110 uses the reflected beams RB11 and RB21 to generate the reflected beams RB12 and RB22 respectively.

Then, the reflected beams RB12 and RB22 can pass through the optical coating 130 and the optical structure 120, and can generate the display image outside the accommodating space Z1.

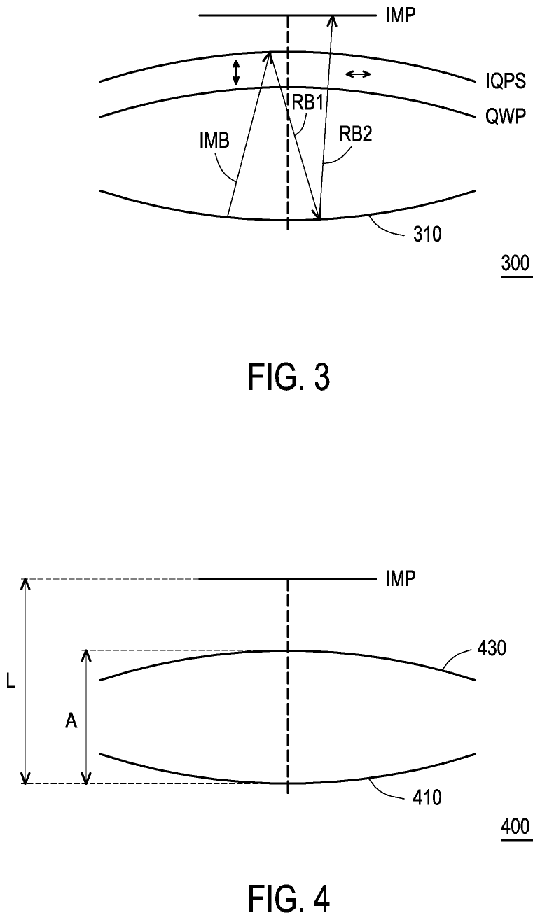

For further description, referring to FIG. 3, which is a schematic diagram illustrating the details of the image light beams of the floating projection device according to the embodiment of the present invention. In the embodiment, the image light beams IMB generated by the display is a circularly polarized light of a first handedness, the first handedness is, for example, right-handed. When the image light beams IMB are transimitted to the phase retardation film layer QWP, the phase retardation film layer QWP can convert the image light beams IMB into a linearly polarized light in a first direction, the first direction is, for example, a vertical direction. In the embodiment, the phase retardation film layer QWP can be a ¼ retardation film.

Then, the polarization selective reflective film layer IQPS can receive the image light beams IMB of the linearly polarized light in the vertical direction, and selectively reflect the image light beams IMB to generate the reflected beam RB1. The reflected beam RB1 can pass through the phase retardation film layer QWP, the phase retardation film layer QWP converts the reflected beam RB1 into the circularly polarized light which is right-handed.

The reflected beam RB1 which is the circularly polarized light of right-handed can be transmitted to the reflective surface of the mirror structure 310. The mirror structure 310 is used to perform a reflection action on the reflected beam RB1 and generate the reflected beam RB2. Wherein, the reflected beam RB2 is the circularly polarized light of the second handed direction (left-handed). Then, the reflected beam RB2 can pass through the phase retardation film layer QWP, and the phase retardation film layer QWP converts the reflected beam RB2 into the linearly polarized light in a second direction, the second direction is, such as the horizontal direction.

The reflected beam RB2 of the linearly polarized light in the horizontal direction can be transimitted to the polarization selective reflective film layer IQPS. And, the polarization selective reflective film layer IQPS can transmit the reflected beam RB2, and make the reflected beam RB2 form the display image on the imaging plane IMP.

Regarding the calculation of the imaging distance of the floating projection device in the embodiment of the present invention, referring to FIG. 4, which is a schematic diagram illustrating the imaging distance of the floating projection device according to an embodiment of the present invention. In the embodiment, the mirror structure 410 and the optical structure 420 in the floating projection device 400 are both concave structures, and have curvature radius R2 and R1 respectively. The vertical distance between the mirror structure 410 and the imaging plane IMP is L (image distance), and the vertical distance between the mirror structure 410 and the optical coating 430 is A. According to formula 1:

$$\frac{1}{Image distance} - \frac{1}{Object distance} = \frac{1}{Focal length} = \frac{2}{Curvature radius of optical structure}$$

Relation 1 can be obtained:

$$\frac{1}{I 1} - \frac{1}{A} = \frac{1}{FR 1} = \frac{2}{R 1} .$$

At this point, A is positive, R1 is negative, and R2 is positive.

Wherein, I1 is the image distance of one imaging, FR1 is the focal length of the optical structure 420.

According to the relation 1, the image distance

$$I 1 = \frac{A \times R 1}{2 A + R 1}$$

of one imaging can be calculated.

Then, according to the image distance I1 of one imaging, the image distance

$$L = \frac{A \times R 2 \times ( P + 1 )}{2 A ( P + 1 ) - R 2}$$

of the secondary imaging can be further calculated, wherein

$$P = \frac{R 1}{2 A + R 1} .$$

Wherein, according to the requirements of floating projection, the image distance L needs to be greater than the distance A. Therefore, in terms of design, the mirror structure 410 with a curvature radius R2 and the optical structure 420 with a curvature radius R1 can be selected, and the floating projection device 400 can effectively generate the display image of the hologram.

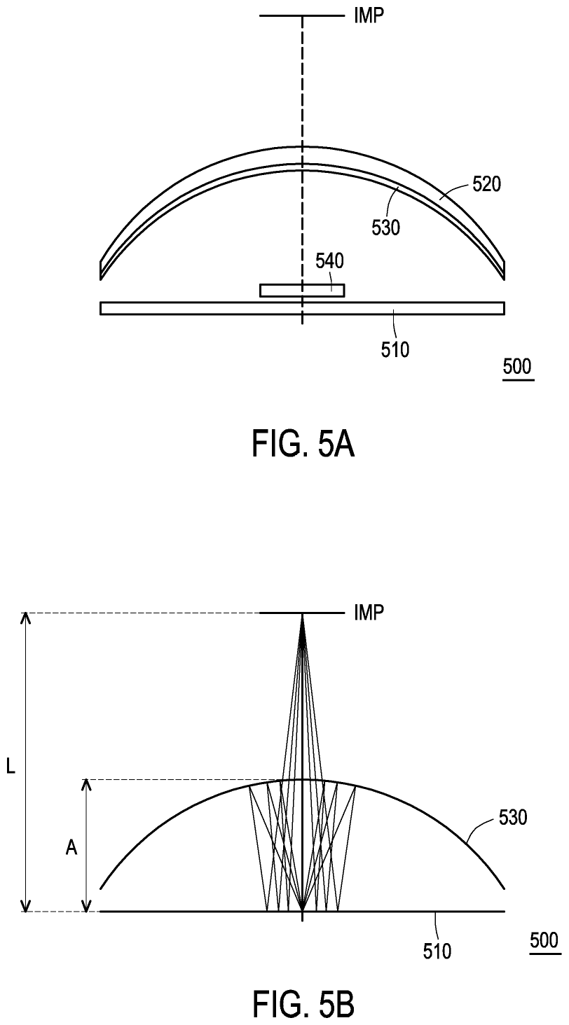

Referring to FIG. 5A and FIG. 5B, wherein FIG. 5A is a schematic diagram of the floating projection device according to an embodiment of the present invention, and FIG. 5B is a schematic diagram illustrating the traveling path of the image light beams of the floating projection device 500 in FIG. 5A. In FIG. 5A, the floating projection device 500 includes a mirror structure 510, an optical structure 520, an optical coating 530 and a display 540. Different from the embodiment in FIG. 1, in this embodiment, the mirror structure 510 can be a planar structure, and the optical structure 520 and the optical coating 530 can be a concave structure. Moreover, the concave surface formed by the optical structure 520 and the optical coating 530 faces the reflective surface of the mirror structure 510.

In FIG. 5B, the image light beams generated by the display 540 can undergo multiple reflections and one transmission between the optical coating 530 and the mirror structure 510, and form the display image on the imaging plane IMP. In the embodiment, the optical coating 530 in the floating projection device 500 has a curvature radius R1. The vertical distance between the mirror structure 510 and the imaging plane IMP is L (image distance), and the vertical distance between the mirror structure 510 and the optical coating 530 is A. According to the above formula 1, relation 2 can be obtained:

$$\frac{1}{I 1} - \frac{1}{A} = \frac{1}{FR 1} = \frac{2}{R 1} ,$$

wherein I1 is the image distance of one imaging, FR1 is the focal length of the optical coating 530. And it can be further deduced that

$$I 1 = \frac{A \times R 1}{2 A + R 1} = A \times P ,$$

wherein

$$P = \frac{R 1}{2 A + R 1} .$$

At this point, A is positive and R1 is negative.

It can be known from the above derivation that the imaging distance of the optical coating 530 is equal to AP. To achieve the floating requirement of the display image, the image of the optical coating 530 can pass through the reflection of the mirror structure 510 and be generated above the optical structure 520. Therefore, the imaging distance of the optical coating 530 must be greater than 2A. Since the display image generated in this case is a real image, the distance A must be greater than one-half of the curvature radius R1. Combining the above factors, the relation 3 can be deduced:

$$\vert \frac{R 1}{2} \vert < A < \vert \frac{3 \times R 1}{4} \vert .$$

That is to say, by selecting the curvature radius R1 of the optical coating 530 conforming to the above relation, the floating projection device 500 can effectively generate the display image of the hologram.

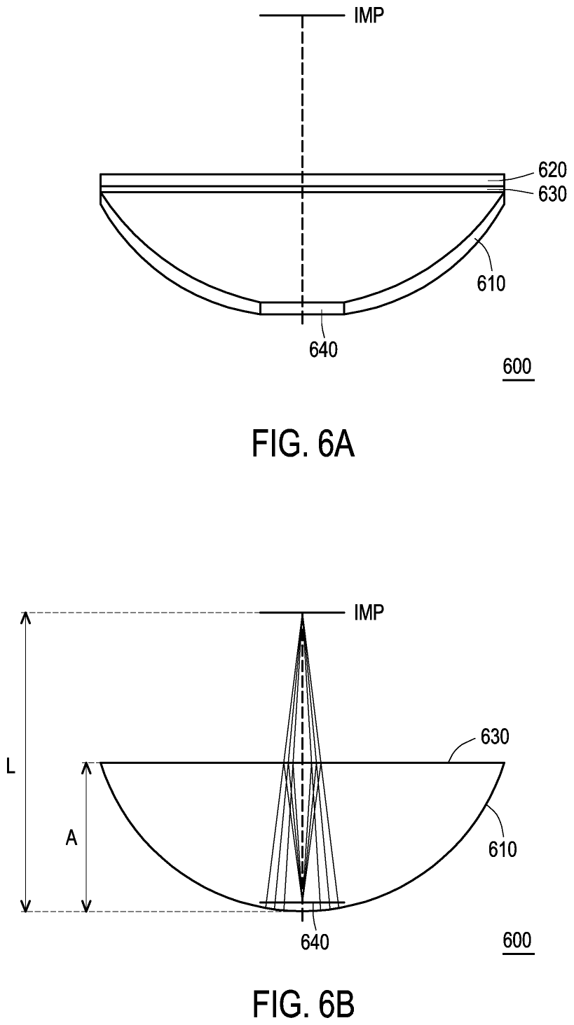

Referring to FIG. 6A and FIG. 6B, wherein FIG. 6A is a schematic diagram of the floating projection device according to an embodiment of the present invention, and FIG. 6B is a schematic diagram illustrating the traveling path of the image light beams of the floating projection device 600 in FIG. 6A. In FIG. 6A, the floating projection device 600 includes a mirror structure 610, an optical structure 620, an optical coating 630 and a display 640. Different from the embodiment in FIG. 1, in this embodiment, the mirror structure 610 can be a concave structure, and the optical structure 620 and the optical coating 630 can be a planar structure. And the concave surface formed by the mirror structure 610 can face the optical structure 620 and the optical coating 630.

In FIG. 6B, the image light beams generated by the display 640 can undergo multiple reflections and one transmission between the optical coating 630 and the mirror structure 610, and form the display image on the imaging plane IMP. In the embodiment, the mirror structure 610 in the floating projection device 600 has the curvature radius R2. The vertical distance between the mirror structure 610 and the imaging plane IMP is L (image distance), and the vertical distance between the mirror structure 610 and the optical coating 630 is A. According to the above formula 1, relation 4 can be obtained:

$$\frac{1}{I 1} - \frac{1}{2 A} = \frac{1}{FR 2} = \frac{2}{R 2} ,$$

wherein I1 is the image distance of one imaging, FR2 is the focal length of the mirror structure 610. And it can be further deduced that

$$\frac{R 1}{4} < \vert A \vert < \frac{3 \times R 2}{4} .$$

At this point, A is negative and R2 is positive.

To meet the floating requirement of the display image, the image distance I1 of one imaging must be greater than the distance A. Since the display image generated in this case is a real image, the distance A must be greater than a quarter of the curvature radius R2. Combining the above factors, the relation 5 can be deduced:

$$I 1 = \frac{2 A \times R 2}{4 A + R 2} .$$

That is to say, by selecting the curvature radius R2 of the mirror structure 610 conforming to the above relation, the floating projection device 600 can effectively generate the display image of the hologram.

In summary, the floating projection device of the present invention has the mirror structure and the optical structure of corresponding setting. Through the optical coating set on the optical structure, the image light beams generated by the display can generate multiple reflections between the optical coating and the optical structure to convert the polarization state of the image light beams. The optical coating transmits image light beams with a specific polarization state onto the floating projection device to generate the hologram above the floating projection device. In this way, the display image generated by the floating projection device can have a relatively wide viewing angle. Moreover, the user will not directly see the image light beams generated by the display, which can effectively avoid the occurrence of visual interference.

What is claimed is:

1. A floating projection device, comprising:
a mirror structure;
an optical structure, covering the mirror structure, forms an accommodating space with the mirror structure;
an optical coating, disposed on the optical structure; and
a display, disposed in the accommodating space formed between the optical structure and the mirror structure, is configured to transmit a plurality of image light beams to the optical structure.

2. The floating projection device according to claim 1, wherein the optical coating is disposed on an inner surface of the optical structure facing the mirror structure.

3. The floating projection device according to claim 1, wherein the optical coating comprises a phase retardation film layer and a polarization selective reflective film layer.

4. The floating projection device according to claim 3, wherein the polarization selective reflective film layer is disposed between the inner surface of the mirror structure and the phase retardation film layer.

5. The floating projection device according to claim 3, wherein the image light beams are reflected a first time on an inner surface of the optical structure and generate a plurality of first reflected beams, the first reflected beams are reflected a second time on a reflective surface of the mirror structure and generate a plurality of second reflected beams, the second reflected beams transmit the inner surface of the optical structure and form a display image which is a real image.

6. The floating projection device according to claim 3, wherein the display projects the image light beams as a circularly polarized light of a first handedness, the phase retardation film layer converts the image light beams into a linearly polarized light in a first direction, the polarization selective reflective film layer reflects the image light beams of the linearly polarized light in the first direction to generate the first reflected beams, the phase retardation film layer then converts the first reflected beams into the circularly polarized light of the first handedness.

7. The floating projection device according to claim 6, wherein a reflective surface of the mirror structure reflects the first reflected beams to generate the second reflected beams as a circularly polarized light of a second handedness.

8. The floating projection device according to claim 7, wherein the phase retardation film layer converts the second reflected beams into a linearly polarized light in a second direction, the polarization selective reflective film layer transmits the second reflected beams of linearly polarized light in the second direction.

9. The floating projection device according to claim 4, wherein the display image is imaged outside the accommodating space and adjacent to an outer surface of the optical structure.

10. The floating projection device according to claim 1, wherein the mirror structure and the optical structure have a first curvature radius and a second curvature radius respectively, and the first curvature radius and the second curvature radius are real numbers other than zero.

11. The floating projection device according to claim 10, wherein a concave surface of the mirror structure faces a concave surface of the optical structure.

12. The floating projection device according to claim 1, wherein one of the mirror structure and the optical structure is a planar structure, the other one of the mirror structure and the optical structure has a curvature radius which is constant, the curvature radius is a real number other than zero.

13. The floating projection device according to claim 1, wherein the optical structure is a transparent structure.
